(19) United States
(12) Patent Application Publication
(10) Pub. No.: US 2026/0196723 A1
(43) Pub. Date: Jul. 9, 2026

(54) METHOD FOR CALIBRATING THE RECEPTION OF PHASED ARRAY ANTENNA WITH BUILT-IN LOCAL OSCILLATOR AND ELECTRONIC DEVICE

(71) Applicant: JCET Management Co., LTD., Shanghai (CN)

(72) Inventors: Wei LIN, Shanghai (CN); Yanbo TANG, Shanghai (CN); Cheng YANG, Shanghai (CN); Boping WU, Shanghai (CN)

(73) Assignee: JCET Management Co., LTD., Shanghai (CN)

(21) Appl. No.: 19/442,536

(22) Filed: Jan. 7, 2026

(30) Foreign Application Priority Data
Jan. 8, 2025 (CN) 202510029818.4
Jan. 8, 2025 (CN) 202510029884.1

(51) Int. Cl. H01Q 3/26; H04B 17/12; H04B 17/21

(52) U.S. Cl. CPC H01Q 3/267; H04B 17/12; H04B 17/221

(57) ABSTRACT

A method for calibrating the reception of a phased array antenna with a built-in local oscillator and an electronic device, are provided. The method includes: constructing and configuring a test system, where a transmitting antenna is located on the central axis of a phased array antenna, and the transmitting antenna is connected to a signal source; dividing the phased array antenna into a plurality of centrally symmetric ring areas according to the central axis of the phased array antenna, and each ring area has one or more centrally symmetric sub-units, and each sub-unit includes a plurality of antenna channels of the same number; and receiving signals using the phased array antenna and transmitting signals with the transmitting antenna, and performing amplitude and phase calibrations between antenna channels within sub-units of the ring areas, between sub-units of the ring areas, and between different ring areas.

### CROSS-REFERENCE TO RELATED APPLICATIONS

This application claims the benefit of priority to Chinese Application No. 202510029818.4, filed on Jan. 8, 2025, which is incorporated herein by reference in its entirety.

### TECHNICAL FIELD

The present application relates to the field of phased array antenna technology, and specifically relates to a method for calibrating the reception of a phased array antenna with a built-in local oscillator and an electronic device.

### BACKGROUND

The phased array antenna generates controllable beams by adjusting the phase and amplitude of each array unit. Compared to mechanical scanning, phased array antenna not only improves scanning speed and flexibility but also can generate a plurality of beams, and therefore, phased array antenna has been widely used in a plurality of fields such as radar, satellite communication, and wireless communication, etc. However, as the integration levels of large-scale phased array antenna increase, the problems of phase and amplitude errors become increasingly prominent, which will result in radiation pattern distortion and system performance degradation. Therefore, precise phase and amplitude calibration is particularly important.

### SUMMARY

The present disclosure provides a method for calibrating the reception of a phased array antenna with a built-in local oscillator and an electronic device.

The embodiments of the disclosure provide a method for calibrating the reception of a phased array antenna with a built-in local oscillator, the method includes the following steps: constructing and configuring a test system, the test system includes a transmitting antenna and a signal source; the transmitting antenna is located on the central axis of a phased array antenna, and the transmitting antenna is connected with the signal source; dividing the phased array antenna according to its layout, dividing the phased array antenna into a plurality of centrally symmetric ring areas according to the central axis of the phased array antenna, and each ring area has one or more centrally symmetric sub-units, and each sub-unit includes a plurality of antenna channels of the same number; and receiving signals using the phased array antenna and transmitting signals with the transmitting antenna, and performing amplitude and phase calibrations between antenna channels within sub-units of the ring areas, between sub-units of the ring areas, and between different ring areas.

In some implementations, the test system further includes a control computer, and one end of the control computer is connected with the phased array antenna for configuring and controlling different antenna channels of the phased array antenna to receive signals, and another end of the control computer is connected with the signal source, and the control computer is used to adjust the frequency and power settings of the signal source.

In some implementations, the ring areas have a plurality of centrally symmetric sub-units, and the sub-units include corner units, x-axis mirror units, and γ-axis mirror units, and the corner units are a plurality of antenna channels located at the four corners of the ring areas, and the x-axis mirror units are a plurality of antenna channels located in the x-axis direction and centrally symmetric in the ring areas, and the y-axis mirror units are a plurality of antenna channels located in the y-axis direction and centrally symmetric in the ring areas.

In some implementations, in the method, a first calibration is performed within the corner units, within the x-axis mirror units, and within the y-axis mirror units, respectively, to obtain first amplitude control values and first phase control values for the corresponding antenna channels; a second calibration is performed between sub-units of the same ring area to obtain second amplitude control values and second phase control values for the corresponding antenna channels; a third calibration is performed between different ring areas to obtain third amplitude control values and third phase control values for the corresponding antenna channels; the first amplitude control values, the second amplitude control values, and the third amplitude control values are summed to obtain final amplitude control values, and the first phase control values, the second phase control values, and the third phase control values are summed to obtain final phase control values.

In some implementations, in the method, when performing the first calibration within a second ring area corner unit, the method includes the following steps: opening a first corner antenna channel, a second corner antenna channel, a third corner antenna channel, and a fourth corner antenna channel of the second ring area corner unit, transmitting test frequency signals by the transmitting antenna, receiving and obtaining corresponding test signals by the first corner antenna channel, the second corner antenna channel, the third corner antenna channel, and the fourth corner antenna channel of the phased array antenna, and the test signals include phase information and amplitude information; based on the phase of the test signal of the first corner antenna channel, obtaining the first phase control values of the corresponding phase shifters of the second corner antenna channel, the third corner antenna channel, and the fourth corner antenna channel, adjusting the phases of the test signals received by the second corner antenna channel, the third corner antenna channel, and the fourth corner antenna channel until the phases of the test signals of the second corner antenna channel, the third corner antenna channel, and the fourth corner antenna channel are the same as the phase of the test signal of the first corner antenna channel, recording the corresponding first phase control values; and based on the amplitude of the test signal of the first corner antenna channel, obtaining the corresponding first amplitude control values of the second corner antenna channel, the third corner antenna channel, and the fourth corner antenna channel, adjusting the amplitudes of the test signals received by the second corner antenna channel, the third corner antenna channel, and the fourth corner antenna channel until the amplitudes of the test signals of the second corner antenna channel, the third corner antenna channel, and the fourth corner antenna channel are the same as the amplitude of the test signal of the first corner antenna channel, recording the corresponding first amplitude control values, completing the first calibration within the second ring area corner unit.

In some implementations, in the method, when performing the first calibration within a second ring area x-axis mirror unit, the method includes the following steps: opening a first x-axis antenna channel, a second x-axis antenna channel, a third x-axis antenna channel, and a fourth x-axis antenna channel of the second ring area corner unit, transmitting test frequency signals by the transmitting antenna, receiving and obtaining corresponding test signals by the first x-axis antenna channel, the second x-axis antenna channel, the third x-axis antenna channel, and the fourth x-axis antenna channel of the phased array antenna, and the test signals include phase information and amplitude information; based on the phase of the test signal of the first x-axis antenna channel, obtaining the first phase control values of the corresponding phase shifters of the second x-axis antenna channel, the third x-axis antenna channel, and the fourth x-axis antenna channel, adjusting the phases of the test signals received by the second x-axis antenna channel, the third x-axis antenna channel, and the fourth x-axis antenna channel until the phases of the test signals of the second x-axis antenna channel, the third x-axis antenna channel, and the fourth x-axis antenna channel are the same as the phase of the test signal of the first x-axis antenna channel, recording the corresponding first phase control values; and based on the amplitude of the test signal of the first x-axis antenna channel, obtaining the corresponding first amplitude control values of the second x-axis antenna channel, the third x-axis antenna channel, and the fourth x-axis antenna channel, adjusting the amplitudes of the test signals received by the second x-axis antenna channel, the third x-axis antenna channel, and the fourth x-axis antenna channel until the amplitudes of the test signals of the second x-axis antenna channel, the third x-axis antenna channel, and the fourth x-axis antenna channel are the same as the amplitude of the test signal of the first x-axis antenna channel, recording the corresponding first amplitude control values, completing the first calibration within the second ring area x-axis unit.

In some implementations, in the method, when performing the first calibration within a second ring area y-axis mirror unit, the method includes the following steps: opening a first y-axis antenna channel, a second y-axis antenna channel, a third y-axis antenna channel, and a fourth y-axis antenna channel of the second ring area corner unit, transmitting test frequency signals by the transmitting antenna, receiving and obtaining corresponding test signals by the first y-axis antenna channel, the second y-axis antenna channel, the third y-axis antenna channel, and the fourth y-axis antenna channel of the phased array antenna, and the test signals include phase information and amplitude information; based on the phase of the corresponding test signal of the first y-axis antenna channel, obtaining the first phase control values of the corresponding phase shifters of the second y-axis antenna channel, the third y-axis antenna channel, and the fourth y-axis antenna channel, adjusting the phases of the test signals received by the second y-axis antenna channel, the third y-axis antenna channel, and the fourth y-axis antenna channel until the phases of the test signals of the second y-axis antenna channel, the third y-axis antenna channel, and the fourth y-axis antenna channel are the same as the phase of the test signal of the first y-axis antenna channel, recording the corresponding first phase control values; and based on the amplitude of the test signal of the first y-axis antenna channel, obtaining the corresponding first amplitude control values of the second y-axis antenna channel, the third y-axis antenna channel, and the fourth y-axis antenna channel, adjusting the amplitudes of the test signals received by the second y-axis antenna channel, the third y-axis antenna channel, and the fourth y-axis antenna channel until the amplitudes of the test signals of the second y-axis antenna channel, the third y-axis antenna channel, and the fourth y-axis antenna channel are the same as the amplitude of the test signal of the first y-axis antenna channel, recording the corresponding first amplitude control values, completing the first calibration within the second ring area y-axis unit.

In some implementations, in the method, when performing the first calibration within a first ring area corner unit, the method includes the following steps: opening a first corner antenna channel, a second corner antenna channel, a third corner antenna channel, and a fourth corner antenna channel of the first ring area corner unit, transmitting test frequency signals by the transmitting antenna, receiving and obtaining corresponding test signals by the first corner antenna channel, the second corner antenna channel, the third corner antenna channel, and the fourth corner antenna channel of the phased array antenna, and the test signals include phase information and amplitude information; based on the phase of the test signal of the first corner antenna channel, obtaining the first phase control values of the corresponding phase shifters of the second corner antenna channel, the third corner antenna channel, and the fourth corner antenna channel, adjusting the phases of the test signals received by the second corner antenna channel, the third corner antenna channel, and the fourth corner antenna channel until the phases of the test signals of the second corner antenna channel, the third corner antenna channel, and the fourth corner antenna channel are the same as the phase of the test signal of the first corner antenna channel, recording the corresponding first phase control values; and based on the amplitude of the test signal of the first corner antenna channel, obtaining the corresponding first amplitude control values of the second corner antenna channel, the third corner antenna channel, and the fourth corner antenna channel, adjusting the amplitudes of the test signals received by the second corner antenna channel, the third corner antenna channel, and the fourth corner antenna channel until the amplitudes of the test signals of the second corner antenna channel, the third corner antenna channel, and the fourth corner antenna channel are the same as the amplitude of the test signal of the first x-axis antenna channel, recording the corresponding first amplitude control values, completing the first calibration within the first ring area corner unit.

In some implementations, in the method, when performing the second calibration between sub-units of the same ring area, the method includes the following steps: opening all corresponding antenna channels of two sub-units of the calibrated same ring area, closing other antenna channels, transmitting test frequency signals by the transmitting antenna, and receiving and obtaining the corresponding test signals of the two sub-units by the opened antenna channels of the phased array antenna; acquiring the test signals of all antenna channels within calibrated one of the sub-units and performing signal superimposition to synthesize a first synthesized signal; acquiring the test signals of all antenna channels within calibrated another sub-unit and performing signal superimposition synthesis; synchronously controlling the amplitude attenuations of all corresponding antenna channels of another sub-unit until the amplitude of the superimposition-synthesized signals of all corresponding antenna channels of the another sub-unit equals α1*P1,

$${α}_{1} = \frac{{D}^{2} + {d}_{2}^{2}}{{D}^{2} + {d}_{1}^{2}} ,$$

and D is the distance from the transmitting antenna to the phase center of the phased array antenna, and d₂ is the distance from the phase center of another sub-unit to the phase center of the phased array antenna; d₁ is the distance from the phase center of one of the sub-units to the phase center of the phased array antenna, and P1 is the amplitude of the first synthesized signal, and obtaining and recording the corresponding second amplitude control values; and maintaining the amplitudes and phases of all antenna channels of one of the sub-units unchanged, synchronously transforming the phases of all antenna channels in another sub-unit until they are the same as the phase of the first synthesized signal of one of the sub-units, obtaining and recording the corresponding second phase control values, completing the second calibration between sub-units of the same ring area.

In some implementations, in the method, when performing the third calibration between different ring areas, the method includes the following steps: opening all antenna channels of one sub-unit of the calibrated first ring area and all antenna channels of one sub-unit of the second ring area, closing other antenna channels, transmitting test frequency signals by the transmitting antenna, receiving and obtaining, by the phased array antenna, the test signals of all corresponding antenna channels of one sub-unit of the first ring area and the test signals of all corresponding antenna channels of one sub-unit of the second ring area, the test signals include phase information and amplitude information; acquiring the test signals of all antenna channels within one sub-unit of the calibrated second ring area and performing signal superimposition to synthesize a first synthesized signal; acquiring the test signals of all antenna channels within one sub-unit of the calibrated first ring area and performing signal superimposition synthesis; synchronously controlling the amplitude attenuations of all corresponding antenna channels of one sub-unit of the first ring area until the amplitude of the superimposition-synthesized signals of all corresponding antenna channels of the one sub-unit equals α3*P1, factor

$${α}_{3} = \frac{{D}^{2} + {d}_{4}^{2}}{{D}^{2} + {d}_{1}^{2}} ,$$

and D is the distance from the transmitting antenna to the phase center of the phased array antenna, and d₄ is the distance from the phase center of one sub-unit of the first ring area to the phase center of the phased array antenna; d₁ is the distance from the phase center of one sub-unit of the second ring area to the phase center of the phased array antenna, and P1 is the amplitude of the first synthesized signal, and obtaining and recording the corresponding third amplitude control values; maintaining the amplitudes and phases of all antenna channels of one sub-unit of the second ring area unchanged, synchronously transforming the phases of the superimposition-synthesized signals of all antenna channels of one sub-unit of the first ring area until they are the same as the phase of the first synthesized signal of one sub-unit of the second ring area, obtaining and recording the corresponding third phase control values, completing the third calibration between different ring areas; and opening in sequence all corresponding antenna channels of one sub-unit of the first ring area and all corresponding antenna channels of one sub-unit of other ring areas simultaneously, repeating the above steps to complete the third calibration for all ring areas.

In some implementations, the phase center of each centrally symmetric sub-unit coincides with the physical center of the phased array antenna.

In some implementations, the method further includes: using a multi-frequency point calibration method to perform multiple calibrations at different frequency points.

In some implementations, the signal source frequency is adjusted to the test frequency; the signal source power is adjusted to the transmission power based on the dynamic range and sensitivity of the phased array antenna.

The present disclosure further provides an electronic device, which includes a processor, a memory, and a computer program stored in the memory and configured to be executed by the processor, and the memory is coupled with the processor, and the processor, when executing the computer program, carries out the above method for calibrating the reception of a phased array antenna.

### BRIEF DESCRIPTION OF THE DRAWINGS

In order to illustrate the technical solutions in the embodiments of the present disclosure or the related art, a brief introduction of the accompanying drawings required for the description of the embodiments or the related art will be given below, and it is obvious that the accompanying drawings described below are merely some embodiments of the present disclosure, and for those skilled in the art, other accompanying drawings can also be obtained according to these drawings without inventive effort.

FIG. 1 is a structural principle schematic diagram for constructing the test system according to the present disclosure;

FIG. 2 is a structural schematic diagram of the phased array antenna divided according to its layout according to an embodiment of the present disclosure;

FIG. 3 is a schematic diagram showing the amplitude of the synthesized signal, which exhibits periodic change with phase difference, resulted from the superimposition of signals of the same frequency according to an embodiment of the present disclosure;

FIG. 4 is a principle schematic diagram of calibrating the corresponding antenna channels of the corner units within the second ring area according to an embodiment of the present disclosure;

FIG. 5a is a schematic diagram of calibrating the phase and amplitude of the corresponding antenna channels of the corner units within the second ring area according to an embodiment of the present disclosure;

FIG. 5b is a transformation schematic diagram of calibrating the phase and amplitude of the corresponding antenna channels of the corner units within the second ring area according to an embodiment of the present disclosure;

FIG. 6a is a schematic diagram of calibrating the phase and amplitude of the corner units within the second ring area according to an embodiment of the present disclosure;

FIG. 6b is a schematic diagram of calibrating the phase and amplitude of the x-axis mirror units within the second ring area according to an embodiment of the present disclosure;

FIG. 6c is a transformation schematic diagram of calibrating the phase and amplitude of the corresponding antenna channels of the x-axis mirror units within the second ring area according to an embodiment of the present disclosure;

FIG. 7 is a principle schematic diagram of calibrating the corresponding antenna channels of the x-axis mirror units within the second ring area according to an embodiment of the present disclosure;

FIG. 8 is a principle schematic diagram of calibrating the corresponding antenna channels of the y-axis mirror units within the second ring area according to an embodiment of the present disclosure; and

FIG. 9 is a principle schematic diagram of calibrating the corresponding antenna channels of the corner units within the first ring area according to an embodiment of the present disclosure.

### DETAILED DESCRIPTION

The phased array antenna generates controllable beams by adjusting the phase and amplitude of each array unit. Compared to mechanical scanning, phased array antenna not only improves scanning speed and flexibility but also can generate a plurality of beams, and therefore, phased array antenna has been widely used in a plurality of fields such as radar, satellite communication, and wireless communication, etc. However, as the integration levels of large-scale phased array antenna increase, the problems of phase and amplitude errors become increasingly prominent, which will result in radiation pattern distortion and system performance degradation. Therefore, precise phase and amplitude calibration is particularly important.

With the increasing demand for high integration and miniaturization applications, the application of AIP (Antenna in Package) technology has become increasingly widespread. Constrained by space limitations, AIP typically does not reserve ports for phased array amplitude and phase testing. To further improve integration level and reduce costs, many solutions have adopted built-in local oscillator technology. However, there is a frequency deviation and random jitter between the built-in local oscillator and instrument signals, and this frequency deviation can be reduced using higher-specification components and more optimized circuit designs.

The vector network analyzer is a commonly used device for measuring antenna parameters, and its testing principle is to measure the S-parameters of the link and process the data to obtain various parameters of the antenna. In vector network measurements, in order to ensure the dynamic range of the test, the test bandwidth needs to be set to a small range, such as 1 KHz. At this time, the difference between the output frequency (e.g., port 1 output) and the receive frequency (e.g., port 2 input) of the vector network needs to be remained within the 1 KHz range of the test bandwidth, and signals exceeding this range will be filtered out. When testing phased array antenna without a built-in local oscillator, since both the output and input frequencies are generated by the vector network, there is no frequency difference, and the testing can be proceeded smoothly.

However, when testing the phased array antenna with a built-in local oscillator, the output frequency of the built-in phased array antenna needs to be configured to be the output frequency of the vector network, and the vector network will then receive at the receiving frequency. But when the phased array to be tested uses a built-in local oscillator, since the crystal oscillator is not shared with the vector network, there is a significant frequency deviation between the output frequency of the phased array antenna and the output frequency of the vector network, even if the target frequency values of the two configurations are the same. This deviation typically exceeds the intermediate frequency bandwidth range.

Additionally, in order to maintain cost-effectiveness, high specification crystal oscillators similar to those used in measuring instruments are usually not used for the built-in local oscillator of phased array antennas. This results in significant frequency jitter over time, which in turn increases the instability of frequency deviation and further widens the deviation. In this case, the reception function of the vector network analyzer will not be able to be implemented, resulting in the entire test process being unable to proceed. Therefore, there is an urgent need to develop a reception calibration method for phased array antennas with a built-in local oscillator.

After completing amplitude and phase calibration, a phased array antenna is typically referred to as the “calibrated state”. In this state, the performance parameters of the antenna, such as amplitude and phase response, have been precisely adjusted to ensure that the antenna array can work together in an expected manner to form the required beam shape and direction. The calibration process is crucial for improving the performance of antenna system, as it can compensate for performance changes caused by factors such as manufacturing tolerances, component aging, temperature changes, etc. After calibration, the antenna array can more accurately control the direction of the beam, and improve signal transmission efficiency and reception sensitivity, and meanwhile it can also reduce sidelobes and backlobes, thereby improving the anti-interference ability of the system.

In order to make the objects, technical solutions, and advantages of the embodiments of the present disclosure clearer, the technical solutions in the embodiments of the present disclosure will be described below in conjunction with the accompanying drawings of the embodiments of the present disclosure. Obviously, the described embodiments are merely a part of embodiments of the present disclosure, not all embodiments. Based on the embodiments of the present disclosure, all other embodiments obtained by those skilled in the art without inventive effort are within the protection scope of the present disclosure.

The beneficial effects of the present disclosure include the following.

In the present disclosure, by dividing the phased array antenna into a plurality of different sub-units according to its layout, and locating the transmitting antenna on the central axis of the phased array antenna, and by performing amplitude and phase calibration within sub-units of the ring areas, between sub-units of the ring areas, and between different ring areas, the calibration for the reception of the entire phased array antenna is achieved. When executing the calibration procedure, the transmitting antenna does not need to perform any movement operations. Since the logical basis of the calibration process is to ensure that the antenna units at geometrically symmetric positions have zero phase difference in their path when transmitting signals. This means that when signals arrive at different antenna channels of the phased array antenna from the transmitting antenna, their arrival times are consistent, thereby ensuring phase consistency. Additionally, the phase center of each geometrically symmetric sub-unit should coincide with the physical center of the entire phased array antenna. This design may ensure that the propagation paths and phase differences of the signals in each sub-unit are precisely controlled and coordinated, so that the performance of the entire antenna system is optimized. This design significantly improves the efficiency of calibration operations, making the entire process more efficient and convenient, particularly for phased array systems that integrate local oscillators.

The present disclosure effectively solves a core problem in the traditional vector network analyzer (vector network) test system, i.e., the signal synchronization problem, and benefit from the phased array antenna calibration method described above, a first calibration is performed within the corner units, within the x-axis mirror units, and within the y-axis mirror units, respectively, to obtain first amplitude control values and first phase control values for the corresponding antenna channels; a second calibration is performed between sub-units of the same ring area to obtain second amplitude control values and second phase control values for the corresponding antenna channels; a third calibration is performed between different ring areas to obtain third amplitude control values and third phase control values for the corresponding antenna channels, so that the calibration for the reception of the entire phased array antenna is achieved. The calibration technology of the present disclosure is not only applicable to phased array systems with integrated local oscillators, but also can be widely used for calibration operations of various highly integrated active phased array radars (AIP phased arrays). Therefore, the present disclosure has broad application prospects and practical application value in the field of radar system calibration.

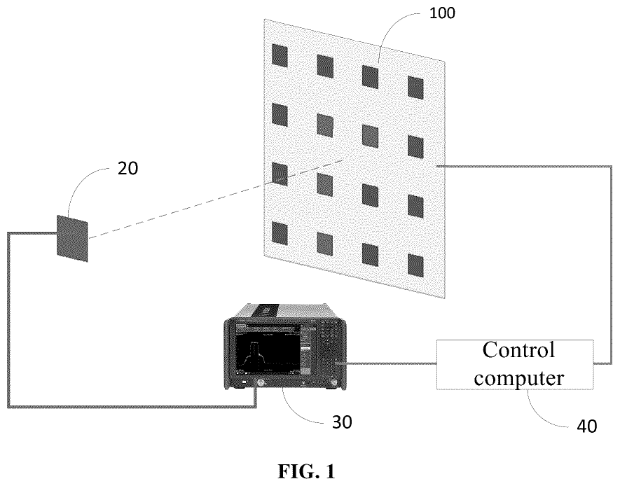

In the implementation of the present disclosure, referring to FIG. 1, the test system includes a transmitting antenna 20, a signal source 30 for providing signals, and a control computer 40, and in the reception calibration method, the transmitting antenna 20 is connected with the signal source 30, and one end of the control computer 40 is connected with the signal source 30 for configuring and controlling different transmission signals, and another end of the control computer 40 is connected with the phased array antenna 100, the corresponding amplitude control values and phase control values of the phased array antenna 100 are obtained using the control computer 40.

The embodiments of the disclosure first provide a method for calibrating the reception of a phased array antenna with a built-in local oscillator, which includes the following steps: constructing and configuring a test system, the test system includes a transmitting antenna and a signal source; the transmitting antenna is located on the central axis of a phased array antenna, and the transmitting antenna is connected with the signal source; dividing the phased array antenna according to its layout, dividing the phased array antenna into a plurality of centrally symmetric ring areas according to the central axis of the phased array antenna, and each ring area has one or more centrally symmetric sub-units, and each sub-unit includes a plurality of antenna channels of the same number; and receiving signals using the phased array antenna and transmitting signals by the transmitting antenna, and performing amplitude and phase calibrations between antenna channels within sub-units of the ring areas, between sub-units of the ring areas, and between different ring areas, thereby achieving the calibration for the reception of the entire phased array antenna.

In some implementations, the test system is constructed and configured, the transmitting antenna 20 is located on the central axis of the phased array antenna 100, and the transmitting antenna 20 is connected with the signal source 30, and signals are transmitted using the transmitting antenna 20, and signals are received by the phased array antenna 100, amplitude and phase calibrations are performed between antenna channels within sub-units of the ring area, between sub-units of the ring area, and between different ring areas, thereby achieving the calibration for the reception of the entire phased array antenna.

The phased array antenna is divided according to its layout, and is divided into a plurality of centrally symmetric ring areas according to the central axis of the phased array antenna, and each ring area has one or more centrally symmetric sub-units, and each sub-unit includes a plurality of antenna channels of the same number.

The phased array antenna is used to transmit signals, and the amplitude and phase calibrations are performed within sub-units of the ring areas, between sub-units of the ring areas, and between different ring areas, to achieve the calibration for the transmission of the entire phased array antenna.

In the present implementation, during the process of constructing and configuring the test system, the transmitting antenna 20 needs to be precisely arranged on the central axis of the phased array antenna 100. Additionally, the transmitting antenna 20 needs to be arranged at a far-field working distance of the phased array antenna 100, because the far-field working distance can provide a uniform plane wave, so that the accuracy and consistency of test data are ensured.

When the signal source 30 is connected with the control computer 40 and appropriate transmission parameters, e.g., frequency, power, modulation scheme, are arranged, the transmitting antenna is activated to make the transmitting antenna begin transmitting test frequency signals, and at this time, the corresponding antenna channel of the phased array antenna 100 will receive signals from the transmitting antenna and performs real-time analysis on them.

Wherein in the present embodiment, the frequency range of the signal source is set according to the dynamic range and sensitivity of the phased array antenna, and recorded into the control computer 40.

In the present embodiment, in order to further improve the precision and efficiency of calibration, we use an automated calibration process. The control computer automatically controls the entire calibration process through a dedicated software program. This program can automatically adjust the settings of the signal source according to preset test parameters and monitor test data in real-time.

Firstly, the frequency range of the signal source 30 is set by the control computer 40 to the required range of test frequency; based on the dynamic range and sensitivity of the phased array antenna 100, the power range of the signal source 30 is set within the dynamic range, so that the receiving path is not saturated and has sufficient signal-to-noise ratio, avoiding overload or insufficient signal-to-noise ratio.

Subsequently, the transmitting antenna 20 begins to transmit the test frequency signal, the corresponding antenna channels of the phased array antenna 100 receive and analyze the test signal in real-time, and transfer the analysis results to the control computer 40, and the control computer 40 controls the phased array antenna 100 to complete the calibration.

In the present embodiment, the ring areas have a plurality of centrally symmetric sub-units, and the sub-units comprise corner units, x-axis mirror units, and γ-axis mirror units, and the corner units are a plurality of antenna channels located at the four corners of the ring areas, and the x-axis mirror units are a plurality of antenna channels in the ring areas which are located in the x-axis direction and centrally symmetric, and the y-axis mirror units are a plurality of antenna channels in the ring areas which are located in the y-axis direction and centrally symmetric.

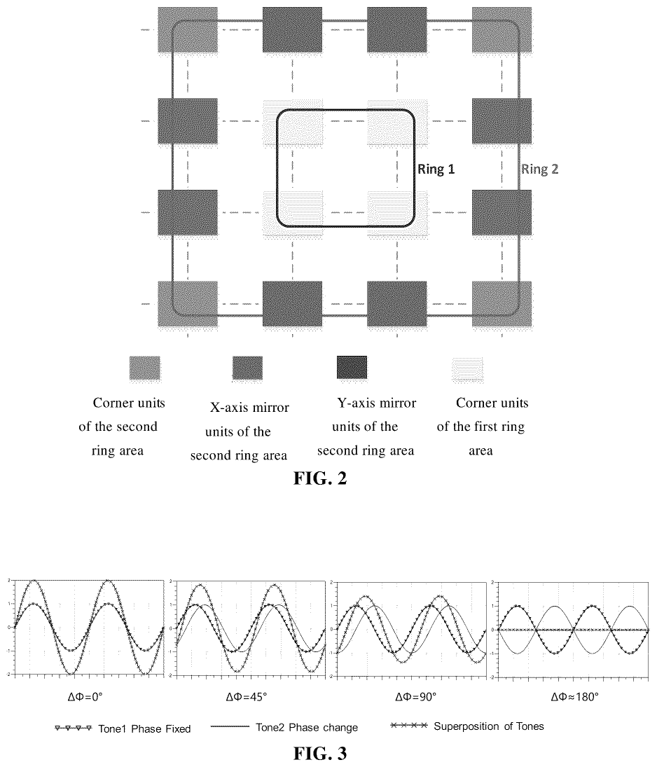

In some implementations, referring to FIG. 2, the phased array antenna used in the present embodiment is a 4*4 array including 16 antenna channels; in other embodiments, the phased array antenna may also be of other specifications, such as a 6*6 array or an 8*8 array, etc.

In the present embodiment, the phased array antenna is divided into two ring areas, a first ring area Ring1 located in the middle and a second ring area Ring2 located in the periphery, wherein the second ring area includes three centrally symmetric sub-units—a corner unit, an x-axis mirror unit, and a y-axis mirror unit, and the second ring area corner unit includes four corner antenna channels located at the corner positions of the second ring area, and the second ring area x-axis mirror unit includes four x-axis antenna channels located in the x-axis direction of the second ring area, and the second ring area y-axis mirror unit includes four y-axis antenna channels located in the y-axis direction of the second ring area, and the first ring area includes the first ring area corner units, the first ring area corner units are located at the corner positions of the first ring area.

In other embodiments, when the phased array antenna is of other specifications, such as 6*6 or 8*8, etc., the phased array antenna is divided into 3, 4, or even more ring areas, and each peripheral ring area includes a plurality of sub-units, specifically one corner unit, one or more x-axis mirror units and Y-axis mirror units, wherein the number of antenna channels of the different sub-units is the same, for example, all is four, and the phase center of each centrally symmetric sub-unit coincides with the physical center of the phased array antenna.

In the present embodiment, calibration is performed within the corresponding corner units, within the x-axis mirror units, and within the y-axis mirror units of different ring areas of the phased array antenna, calibration is also performed between sub-units of the same ring area and between different ring areas, respectively.

In some implementations, a first calibration is performed within the corner units, within the x-axis mirror units, and within the y-axis mirror units, respectively, to obtain first amplitude control values and first phase control values for the corresponding antenna channels; a second calibration is performed between sub-units of the same ring area to obtain second amplitude control values and second phase control values for the corresponding antenna channels; a third calibration is performed between different ring areas to obtain third amplitude control values and third phase control values for the corresponding antenna channels; the first amplitude control values, the second amplitude control values, and the third amplitude control values are summed to obtain final amplitude control values, and the first phase control values, the second phase control values, and the third phase control values are summed to obtain final phase control values, so that the calibration for the transmission of the entire phased array antenna is achieved.

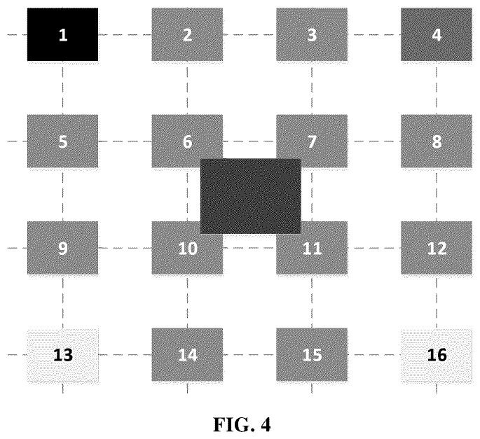

In some implementations, referring to FIG. 4, when performing the first calibration within the corner units of the second ring area, the method includes the following steps.

A first corner antenna channel 1, a second corner antenna channel 4, a third corner antenna channel 16, and a fourth corner antenna channel 13 of the second ring area corner unit are opened, test frequency signals are transmitted by the transmitting antenna, corresponding test signals are received and obtained by the first corner antenna channel 1, the second corner antenna channel 4, the third corner antenna channel 16, and the fourth corner antenna channel 13 of the phased array antenna, and the test signals comprise phase information and amplitude information.

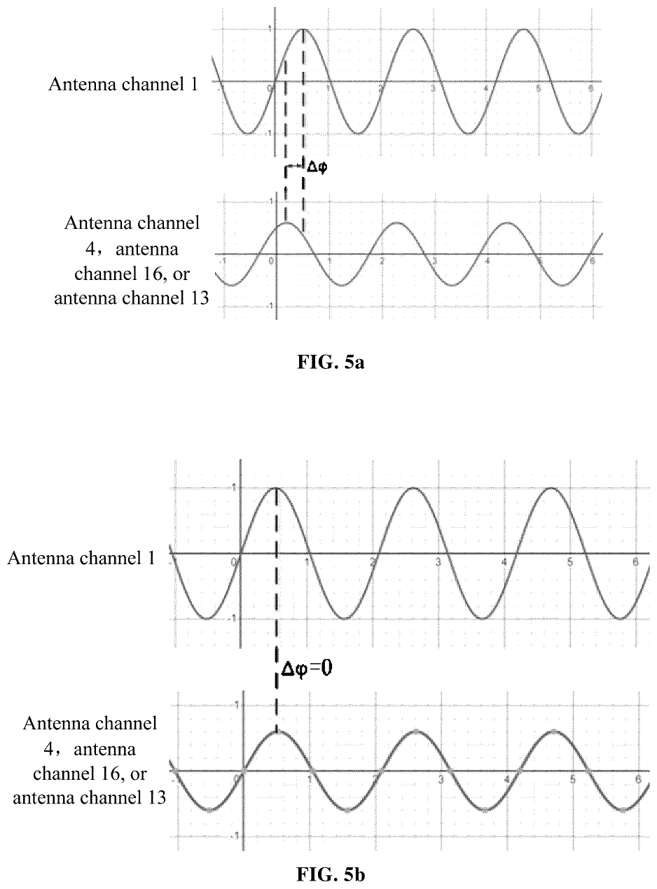

Referring to FIGS. 5a and 5b, based on the phase of the test signal of the first corner antenna channel 1, the first phase control values of the corresponding phase shifters of the second corner antenna channel 4, the third corner antenna channel 16, and the fourth corner antenna channel 13 are obtained, the phases of the test signals received by the second corner antenna channel 4, the third corner antenna channel 16, and the fourth corner antenna channel 13 are adjusted until the phases of the test signals of the second corner antenna channel 4, the third corner antenna channel 16, and the fourth corner antenna channel 13 are the same as the phase of the test signal of the first corner antenna channel 1, the corresponding first phase control values are recorded, wherein Δφ in FIGS. 5a to 5b is the phase difference value between the phase of the test signal of the first corner antenna channel 1 and the phase of the test signal of the second corner antenna channel 4, the third corner antenna channel 16, or the fourth corner antenna channel 13.

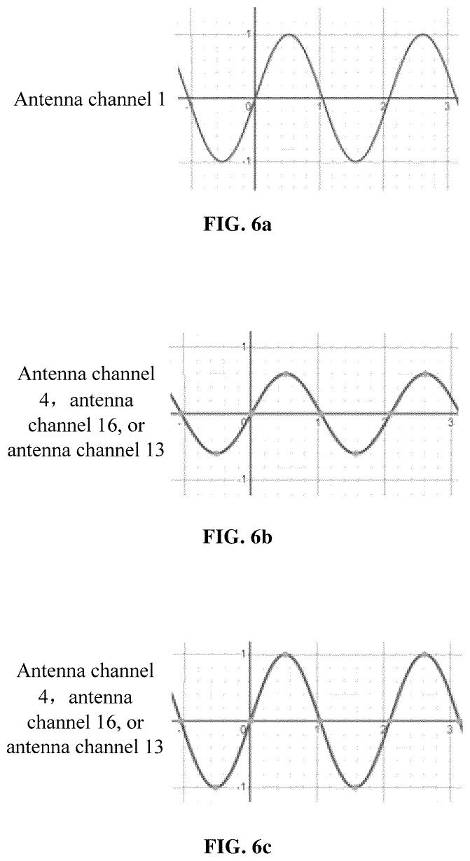

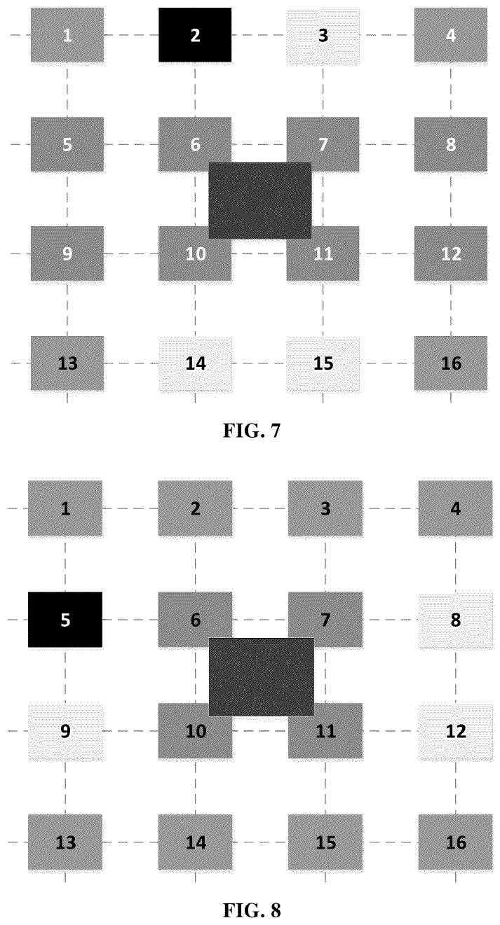

Referring to FIGS. 6a to 6c, based on the amplitude of the test signal of the first corner antenna channel 1, the corresponding first amplitude control values of the second corner antenna channel 4, the third corner antenna channel 16, and the fourth corner antenna channel 13 are obtained, the amplitudes of the test signals received by the second corner antenna channel 4, the third corner antenna channel 16, and the fourth corner antenna channel 13 are adjusted until the amplitudes of the test signals of the second corner antenna channel 4, the third corner antenna channel 16, and the fourth corner antenna channel 13 are the same as the amplitude of the test signal of the first corner antenna channel 1, the corresponding first amplitude control values are recorded, and the first calibration within the second ring area corner unit is completed.

In the present embodiment, the first corner antenna channel 1 is used as the reference antenna channel to calibrate the second corner antenna channel 4, the third corner antenna channel 16, and the fourth corner antenna channel 13, respectively.

In other embodiments, the second corner antenna channel 4, the third corner antenna channel 16, or the fourth corner antenna channel 13 may also be used as the reference antenna channel to calibrate other three corner antenna channels, and in other embodiments, the first corner antenna channel, the second corner antenna channel, the third corner antenna channel, and the fourth corner antenna channel may also be interchanged.

In some implementations, referring to FIG. 7, when performing the first calibration within a second ring area x-axis mirror unit, the method includes the following steps.

A first x-axis antenna channel 2, a second x-axis antenna channel 3, a third x-axis antenna channel 15, and a fourth x-axis antenna channel 14 of the second ring area corner unit are opened, test frequency signals are transmitted by the transmitting antenna, corresponding test signals are received and obtained by the first x-axis antenna channel 2, the second x-axis antenna channel 3, the third x-axis antenna channel 15, and the fourth x-axis antenna channel 14 of the phased array antenna, and the test signals comprise phase information and amplitude information.

Based on the phase of the test signal of the first x-axis antenna channel 2, the first phase control values of the corresponding phase shifters of the second x-axis antenna channel 3, the third x-axis antenna channel 15, and the fourth x-axis antenna channel 14 are obtained, the phases of the test signals received by the second x-axis antenna channel 3, the third x-axis antenna channel 15, and the fourth x-axis antenna channel 14 are adjusted until the phases of the test signals of the second x-axis antenna channel 3, the third x-axis antenna channel 15, and the fourth x-axis antenna channel 14 are the same as the phase of the test signal of the first x-axis antenna channel 2, the corresponding first phase control values are recorded.

Based on the amplitude of the test signal of the first x-axis antenna channel 2, the corresponding first amplitude control values of the second x-axis antenna channel 3, the third x-axis antenna channel 15, and the fourth x-axis antenna channel 14 are obtained, the amplitudes of the test signals received by the second x-axis antenna channel 3, the third x-axis antenna channel 15, and the fourth x-axis antenna channel 14 are adjusted until the amplitudes of the test signals of the second x-axis antenna channel 3, the third x-axis antenna channel 15, and the fourth x-axis antenna channel 14 are the same as the amplitude of the test signal of the first x-axis antenna channel 2, the corresponding first amplitude control values are recorded, and the first calibration within the second ring area x-axis unit is completed.

In the present embodiment, the first x-axis antenna channel 2 is used as the reference antenna channel to calibrate the second x-axis antenna channel 3, the third x-axis antenna channel 15, and the fourth x-axis antenna channel 14, respectively.

In other embodiments, the second x-axis antenna channel 3, the third x-axis antenna channel 15, the fourth x-axis antenna channel 14 may also be used as reference antenna channel to calibrate other three x-axis antenna channels, and in other embodiments, the first x-axis antenna channel, the second x-axis antenna channel, the third x-axis antenna channel, and the fourth x-axis antenna channel may also be interchanged.

In some implementations, referring to FIG. 8, when performing the first calibration within a second ring area y-axis mirror unit, the method includes the following steps.

A first y-axis antenna channel 5, a second y-axis antenna channel 8, a third y-axis antenna channel 12, and a fourth y-axis antenna channel 9 of the second ring area corner unit are opened, test frequency signals are transmitted by the transmitting antenna, corresponding test signals are received and obtained by the first y-axis antenna channel 5, the second y-axis antenna channel 8, the third y-axis antenna channel 12, and the fourth y-axis antenna channel 9 of the phased array antenna, and the test signals comprise phase information and amplitude information.

Based on the phase of the corresponding test signal of the first y-axis antenna channel 5, the first phase control values of the corresponding phase shifters of the second y-axis antenna channel 8, the third y-axis antenna channel 12, and the fourth y-axis antenna channel 9 are obtained, the phases of the test signals received by the y-axis antenna channel 8, the third y-axis antenna channel 12, and the fourth y-axis antenna channel 9 are adjusted until the phases of the test signals of the y-axis antenna channel 8, the third y-axis antenna channel 12, and the fourth y-axis antenna channel 9 are the same as the phase of the test signal of the first y-axis antenna channel 5, the corresponding first phase control values are recorded.

Based on the amplitude of the test signal of the first y-axis antenna channel 5, the corresponding first amplitude control values of the second y-axis antenna channel 8, the third y-axis antenna channel 12, and the fourth y-axis antenna channel 9 are obtained, the amplitudes of the test signals received by the second y-axis antenna channel 8, the third y-axis antenna channel 12, and the fourth y-axis antenna channel 9 are adjusted until the amplitudes of the test signals of the second y-axis antenna channel 8, the third y-axis antenna channel 12, and the fourth y-axis antenna channel 9 are the same as the amplitude of the test signal of the first x-axis antenna channel 2, the corresponding first amplitude control values are recorded, and the first calibration within the second ring area y-axis mirror unit is completed.

In the present embodiment, the first y-axis antenna channel 5 is used as the reference antenna channel to calibrate the second y-axis antenna channel 8, the third y-axis antenna channel 12, and the fourth y-axis antenna channel 9, respectively.

In other embodiments, the second y-axis antenna channel 8, the third y-axis antenna channel 12, the fourth y-axis antenna channel 9 may also be used as reference antenna channel to calibrate other three y-axis antenna channels, and in other embodiments, the first y-axis antenna channel, the second y-axis antenna channel, the third y-axis antenna channel, and the fourth y-axis antenna channel may also be interchanged.

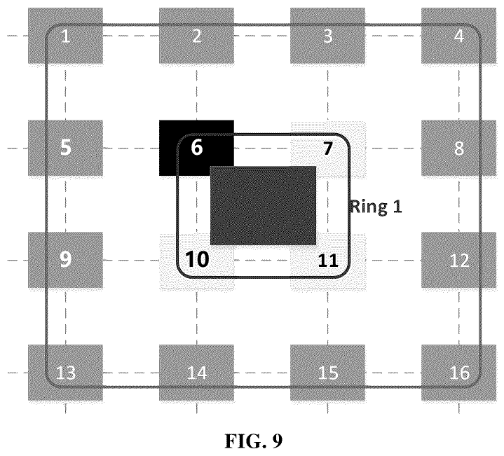

In some implementations, referring to FIG. 9, when performing the first calibration within a first ring area corner unit, the method includes the following steps.

A first corner antenna channel 6, a second corner antenna channel 7, a third corner antenna channel 11, and a fourth corner antenna channel 10 of the first ring area corner unit are opened, test frequency signals are transmitted by the transmitting antenna, corresponding test signals are received and obtained by the first corner antenna channel 6, the second corner antenna channel 7, the third corner antenna channel 11, and the fourth corner antenna channel 10 of the phased array antenna, and the test signals comprise phase information and amplitude information.

Based on the phase of the test signal of the first corner antenna channel 6, the first phase control values of the corresponding phase shifters of the second corner antenna channel 7, the third corner antenna channel 11, and the fourth corner antenna channel 10 are obtained, the phases of the test signals received by the second corner antenna channel 7, the third corner antenna channel 11, and the fourth corner antenna channel 10 are adjusted until the phases of the test signals of the second corner antenna channel 7, the third corner antenna channel 11, and the fourth corner antenna channel 10 are the same as the phase of the test signal of the first corner antenna channel 6, the corresponding first phase control values are recorded.

Based on the amplitude of the test signal of the first corner antenna channel 6, the corresponding first amplitude control values of the second corner antenna channel 7, the third corner antenna channel 11, and the fourth corner antenna channel 10 are obtained, the amplitudes of the test signals received by the second corner antenna channel 7, the third corner antenna channel 11, and the fourth corner antenna channel 10 are adjusted until the amplitudes of the test signals of the second corner antenna channel 7, the third corner antenna channel 11, and the fourth corner antenna channel 10 are the same as the amplitude of the test signal of the first x-axis antenna channel 2, the corresponding first amplitude control values are recorded, and the first calibration within the first ring area corner unit is completed.

In the present embodiment, the first corner antenna channel 6 of the first ring area is used as the reference antenna channel to calibrate the second corner antenna channel 7, the third corner antenna channel 11, and the fourth corner antenna channel 10, respectively.

In other embodiments, second corner antenna channel 7, third corner antenna channel 11, or fourth corner antenna channel 10 may also be used as the reference antenna channel to calibrate other three corner antenna channels, and in other embodiments, the first corner antenna channel, the second corner antenna channel, the third corner antenna channel, and the fourth corner antenna channel may also be interchanged.

Furthermore, in the method, when performing the second calibration between the corner unit sub-units and the x-axis mirror unit sub-units of the second ring area, the method includes the following steps.

All corresponding antenna channels of the calibrated second ring area corner unit and all corresponding antenna channels of the calibrated second ring area x-axis mirror unit are opened, and other antenna channels are closed, test frequency signals are transmitted by the transmitting antenna, the corresponding test signals of all antenna channels within the second ring area corner unit and the corresponding test signals of all antenna channels within the second ring area x-axis mirror unit are received and obtained by the opened antenna channels of the phased array antenna, and the test signals include phase information and amplitude information.

The test signals of all antenna channels within the calibrated second ring area corner unit are acquired and undergo signal superimposition to synthesize a first synthesized signal.

The test signals of all antenna channels within the calibrated second ring area x-axis mirror unit are acquired and signal superimposition synthesis is performed.

The amplitude attenuations of all corresponding antenna channels within the calibrated second ring area x-axis mirror unit are synchronously controlled until the amplitude of the signal synthesized by superimposing all corresponding antenna channels of the second ring area x-axis mirror unit equals α1*P1, factor

$${α}_{1} = \frac{{D}^{2} + {d}_{2}^{2}}{{D}^{2} + {d}_{1}^{2}} ,$$

and D is the distance from the transmitting antenna to the phase center of the phased array antenna, and d₂ is the distance from the phase center of the x-axis mirror unit to the phase center of the phased array antenna; d₁ is the distance from the phase center of the corner unit to the phase center of the phased array antenna, the corresponding second amplitude control values are obtained and recorded.

The amplitudes and phases of all antenna channels of the second ring area corner unit are maintained unchanged, the phases of all antenna channels of the second ring area x-axis mirror unit are synchronously transformed, until they are the same as the phase of the first synthesized signal of the second ring area corner unit, the corresponding second phase control values are obtained and recorded, the calibrations of the corner unit sub-unit and x-axis mirror unit sub-unit of the second ring area are completed.

In the present embodiment, the second ring area corner unit is used as the reference unit to calibrate the second ring area x-axis mirror unit, in other embodiments, any one sub-unit of the same ring area may also be selected as the reference unit to calibrate other sub-units.

Furthermore, when performing the second calibration between the corner units and the y-axis mirror unit sub-units of the second ring area, the method includes the following steps.

All corresponding antenna channels of the calibrated second ring area corner unit and all corresponding antenna channels of the calibrated second ring area y-axis mirror unit are opened, and other antenna channels are closed, test frequency signals are transmitted by the transmitting antenna, the corresponding test signals of all antenna channels within the second ring area corner unit and the corresponding test signals of all antenna channels within the second ring area y-axis mirror unit are received and obtained by the opened antenna channels of the phased array antenna, and the test signals include phase information and amplitude information.

The test signals of all antenna channels within the calibrated second ring area corner unit are acquired and undergo signal superimposition to synthesize a first synthesized signal.

The test signals of all antenna channels within the calibrated second ring area y-axis mirror unit are acquired and performed signal superimposition synthesis.

The amplitude attenuations of all corresponding antenna channels within the calibrated second ring area y-axis mirror unit are synchronously controlled until the amplitude of the signal synthesized by superimposing all corresponding antenna channels of the second ring area y-axis mirror unit equals α2*P1, factor

$${α}_{2} = \frac{{D}^{2} + {d}_{3}^{2}}{{D}^{2} + {d}_{1}^{2}} ,$$

and D is the distance from the transmitting antenna to the phase center of the phased array antenna, and d₃ is the distance from the phase center of the y-axis mirror unit to the phase center of the phased array antenna; d₁ is the distance from the phase center of the corner unit to the phase center of the phased array antenna, and P1 is the amplitude of the first synthesized signal, the corresponding second amplitude control values are obtained and recorded.

The amplitudes and phases of all antenna channels of the corner unit of the second ring area are maintained unchanged, the phases of all antenna channels of the y-axis mirror unit of the second ring area are synchronously transformed, until they are the same as the phase of the first synthesized signal of the corner unit of the second ring area, the corresponding second phase control values are obtained and recorded, the second calibration between the corner units and the y-axis mirror unit sub-units of the second ring area is completed.

In the present embodiment, the second ring area corner unit is used as the reference unit to calibrate the second ring area y-axis mirror unit, in other embodiments, any one sub-unit of the same ring area may also be selected as the reference unit to calibrate other sub-units.

Furthermore, when performing the third calibration between different ring areas in the method, the method includes the following steps.

All antenna channels of the calibrated first ring area corner unit and all antenna channels of the calibrated second ring area corner unit are opened, and other antenna channels are closed, test frequency signals are transmitted by the transmitting antenna, the test signals of all corresponding antenna channels of the first ring area corner unit and the test signals of all corresponding antenna channels of the second ring area corner unit are received and obtained by the opened antenna channels of the phased array antenna, and the test signals include phase information and amplitude information.

The test signals of all antenna channels within the calibrated second ring area corner unit are acquired and undergo signal superimposition to synthesize a first synthesized signal.

The test signals of all antenna channels within the calibrated first ring area y-axis mirror unit are acquired and undergo signal superimposition synthesis.

The amplitude attenuations of all corresponding antenna channels of the first ring area corner unit are synchronously controlled until the amplitude of the signal synthesized by superimposing all corresponding antenna channels of the first ring area corner unit equals α3*P1, factor

$${α}_{3} = \frac{{D}^{2} + {d}_{4}^{2}}{{D}^{2} + {d}_{1}^{2}} ,$$

and D is the distance from the transmitting antenna to the phase center of the phased array antenna, and d₄ is the distance from the phase center of the corner unit of the first ring area to the phase center of the phased array antenna; d₁ is the distance from the phase center of the corner unit to the phase center of the phased array antenna, and P1 is the amplitude of the first synthesized signal, the corresponding third amplitude control values are obtained and recorded.

The amplitudes and phases of all antenna channels of the second ring area corner unit are maintained unchanged, the phases of all antenna channels of the first ring area corner unit are synchronously transformed until they are the same as the phase of the first synthesized signal of the second ring area corner unit, the corresponding third phase control values are obtained and recorded, the third calibrations between different ring areas are completed.

In the present embodiment, the corner unit of the second ring area is used as the reference unit to calibrate the corner unit of the first ring area, thereby achieving calibration of the first ring area using the second ring area. In other embodiments, any one ring area may also be selected as the reference unit to calibrate other ring areas.

In the present embodiment, the logical basis of the calibration process is to ensure that the antenna units at geometrically symmetric positions have zero phase difference in their path when receiving signals. This means that when signals propagate from the transmitting antenna to different antenna channel units of the phased array antenna, their arrival times are consistent, thereby ensuring phase consistency. Additionally, the phase center of each geometrically symmetric sub-unit should coincide with the physical center of the entire phased array antenna. This design ensures that the propagation paths and phase differences of the signals in each sub-unit are precisely controlled and coordinated, thereby optimizing the performance of the entire antenna system.

In the present embodiment, during the calibration process, the amplitude value of the reference unit is set to an intermediate value to calibrate other units.

Furthermore, as shown in FIG. 3, when a plurality of signals of the same frequency are superimposed in the antenna system, the amplitude of the synthesized signal will exhibit periodic changes with the changes in phase difference. This periodic change is due to interference effects caused by phase differences between different signals. By precisely controlling and adjusting the phase difference of each antenna unit, precise control of the amplitude of the synthesized signal can be achieved, so that the reception quality and transmission efficiency of the signal are improved. This calibration method is not only applicable for signal processing in static environments but also applicable for dynamically changing communication scenarios, and the stability and reliability of the antenna system under various conditions are ensured.

During implementation of the aforementioned calibration method, the effects of environmental factors on signal propagation also need to be considered. For example, the signal propagation path and phase of signals will be affected by temperature changes, humidity changes, and wind speeds, etc. Therefore, real-time monitoring of these environmental factors is required in practical operations, and the calibration parameters are dynamically adjusted according to monitoring results.

In order to achieve this object, an environmental monitoring module can be introduced, and this module can monitor environmental parameters in real-time and transmit data to the control system. The control system automatically adjusts calibration parameters according to the changes of environmental parameters to ensure the accuracy of the calibration process. For example, when a rise in temperature results in a change in signal propagation speed, the control system will adjust the phase control parameters accordingly to compensate for the effect of temperature changes on the signal propagation path.

Additionally, to further improve the precision of calibration, a multi-frequency point calibration method can be used. Calibrating at different frequency points can ensure phase consistency of the signal throughout the entire working frequency band. During the specific operation, the above calibration process can be repeated at a plurality of predetermined frequency points, and the amplitude attenuation and relative phase control parameters at each frequency point are recorded, and then, through interpolation or fitting methods, and a calibration parameter curve for the entire frequency band is generated, so that precise calibration for any frequency point is achieved.

In one embodiment, the present disclosure further provides an electronic device including a processor, a memory, and a computer program stored in the memory and configured to be executed by the processor, and the memory is coupled with the processor, and the processor, when executing the computer program, carries out the method for calibrating the reception of a phased array antenna with a built-in local oscillator described in the first aspect.

In summary, the calibration logic design used by the present disclosure is extremely streamlined and clear, which ensures the transmitting antenna does not need to perform any movement operations during the execution of the calibration program. This design significantly improves the efficiency of calibration operations, making the entire process more efficient and convenient, particularly for phased array systems that integrate local oscillators.

The calibration technology of the present disclosure is not only applicable to phased array systems with integrated local oscillators, but can also be widely used for calibration operations of various highly integrated active phased array radars (AIP phased arrays). Therefore, the present disclosure has broad application prospects and practical application value in the field of radar system calibration.

The above embodiments are only used to illustrate the technical solutions of the present disclosure and are not intended to limit it; although the present disclosure has been described in detail referring to the aforementioned embodiments, those skilled in the art should understand that they can still modify the technical solutions described in the aforementioned various embodiments, or equivalently substitute some of the technical features; and these modifications or substitutions do not make the essences of the corresponding technical solutions depart from the spirit and scope of the technical solutions in the various embodiments of the present disclosure.

What is claimed is:

1. A method for calibrating a reception of a phased array antenna with a built-in local oscillator, comprising:
constructing and configuring a test system, wherein the test system comprises a transmitting antenna and a signal source, the transmitting antenna is located on a central axis of the phased array antenna, and the transmitting antenna is connected to the signal source;
dividing the phased array antenna according to a layout of the phased array antenna, wherein the layout of the phased array antenna is divided into a plurality of centrally symmetric ring areas according to the central axis of the phased array antenna, and each of the ring areas comprise one or more centrally symmetric sub-units, and each of the sub-units comprises a same number of antenna channels; and
receiving signals using the phased array antenna and transmitting signals by the transmitting antenna, and performing amplitude and phase calibrations between the antenna channels within sub-units of the ring areas, between sub-units of the ring areas, and between the ring areas.

2. The method for calibrating the reception of the phased array antenna with the built-in local oscillator according to claim 1, wherein the test system further comprises:
a control computer, wherein one end of the control computer is connected to the phased array antenna for configuring and controlling the antenna channels of the phased array antenna to receive signals, another end of the control computer is connected to the signal source, and the control computer is used to adjust frequency and power settings of the signal source.

3. The method for calibrating the reception of the phased array antenna with the built-in local oscillator according to claim 1, wherein:
the sub-units comprise corner units, x-axis mirror units, and γ-axis mirror units;
the corner units are units of the antenna channels located at four corners of the ring areas;
the x-axis mirror units are units of the antenna channels located in an x-axis direction and centrally symmetric in the ring areas; and
the y-axis mirror units are units of the antenna channels located in a y-axis direction and centrally symmetric in the ring areas.

4. The method for calibrating the reception of the phased array antenna with the built-in local oscillator according to claim 3, further comprising:
performing a first calibration within the corner units, within the x-axis mirror units, and within the y-axis mirror units, respectively, to obtain first amplitude control values and first phase control values for the corresponding antenna channels;
performing a second calibration between the sub-units of the same ring area to obtain second amplitude control values and second phase control values for the corresponding antenna channels; and
performing a third calibration between the ring areas to obtain third amplitude control values and third phase control values for the corresponding antenna channels,
wherein the first amplitude control values, the second amplitude control values, and the third amplitude control values are summed to obtain final amplitude control values, and the first phase control values, the second phase control values, and the third phase control values are summed to obtain final phase control values.

5. The method for calibrating the reception of the phased array antenna with the built-in local oscillator according to claim 3, wherein when performing a first calibration within a second ring area corner unit, the method comprises:
opening a first corner antenna channel, a second corner antenna channel, a third corner antenna channel, and a fourth corner antenna channel of the second ring area corner unit, transmitting test frequency signals by the transmitting antenna, receiving and obtaining corresponding test signals by the first corner antenna channel, the second corner antenna channel, the third corner antenna channel, and the fourth corner antenna channel of the phased array antenna, and the test signals comprise phase information and amplitude information;
based on phases of the test signals of the first corner antenna channel, obtaining first phase control values of corresponding phase shifters of the second corner antenna channel, the third corner antenna channel, and the fourth corner antenna channel, adjusting the phases of the test signals received by the second corner antenna channel, the third corner antenna channel, and the fourth corner antenna channel until the phases of the test signals of the second corner antenna channel, the third corner antenna channel, and the fourth corner antenna channel are the same as the phases of the test signals of the first corner antenna channel, and recording the corresponding first phase control values; and
based on amplitudes of the test signals of the first corner antenna channel, obtaining corresponding first amplitude control values of the second corner antenna channel, the third corner antenna channel, and the fourth corner antenna channel, adjusting the amplitudes of the test signals received by the second corner antenna channel, the third corner antenna channel, and the fourth corner antenna channel until the amplitudes of the test signals of the second corner antenna channel, the third corner antenna channel, and the fourth corner antenna channel are the same as the amplitudes of the test signals of the first corner antenna channel, and recording the corresponding first amplitude control values.

6. The method for calibrating the reception of the phased array antenna with the built-in local oscillator according to claim 3, wherein when performing a first calibration within a second ring area x-axis mirror unit, the method comprises:
opening a first x-axis antenna channel, a second x-axis antenna channel, a third x-axis antenna channel, and a fourth x-axis antenna channel of a second ring area corner unit, transmitting test frequency signals by the transmitting antenna, receiving and obtaining corresponding test signals by the first x-axis antenna channel, the second x-axis antenna channel, the third x-axis antenna channel, and the fourth x-axis antenna channel of the phased array antenna, and the test signals comprise phase information and amplitude information;
based on phases of the test signals of the first x-axis antenna channel, obtaining first phase control values of corresponding phase shifters of the second x-axis antenna channel, the third x-axis antenna channel, and the fourth x-axis antenna channel, adjusting the phases of the test signals received by the second x-axis antenna channel, the third x-axis antenna channel, and the fourth x-axis antenna channel until the phases of the test signals of the second x-axis antenna channel, the third x-axis antenna channel, and the fourth x-axis antenna channel are the same as the phases of the test signals of the first x-axis antenna channel, and recording the corresponding first phase control values; and
based on amplitudes of the test signals of the first x-axis antenna channel, obtaining corresponding first amplitude control values of the second x-axis antenna channel, the third x-axis antenna channel, and the fourth x-axis antenna channel, adjusting the amplitudes of the test signals received by the second x-axis antenna channel, the third x-axis antenna channel, and the fourth x-axis antenna channel until the amplitudes of the test signals of the second x-axis antenna channel, the third x-axis antenna channel, and the fourth x-axis antenna channel are the same as the amplitudes of the test signals of the first x-axis antenna channel, and recording the corresponding first amplitude control values.

7. The method for calibrating the reception of the phased array antenna with the built-in local oscillator according to claim 3, wherein when performing a first calibration within a second ring area y-axis mirror unit, the method comprises:
opening a first y-axis antenna channel, a second y-axis antenna channel, a third y-axis antenna channel, and a fourth y-axis antenna channel of a second ring area corner unit, transmitting test frequency signals by the transmitting antenna, receiving and obtaining corresponding test signals by the first y-axis antenna channel, the second y-axis antenna channel, the third y-axis antenna channel, and the fourth y-axis antenna channel of the phased array antenna, and the test signals comprise phase information and amplitude information;
based on phases of the corresponding test signals of the first y-axis antenna channel, obtaining first phase control values of corresponding phase shifters of the second y-axis antenna channel, the third y-axis antenna channel, and the fourth y-axis antenna channel, adjusting the phases of the test signals received by the second y-axis antenna channel, the third y-axis antenna channel, and the fourth y-axis antenna channel until the phases of the test signals of the second y-axis antenna channel, the third y-axis antenna channel, and the fourth y-axis antenna channel are the same as the phases of the test signals of the first y-axis antenna channel, and recording the corresponding first phase control values; and
based on amplitudes of the test signals of the first y-axis antenna channel, obtaining corresponding first amplitude control values of the second y-axis antenna channel, the third y-axis antenna channel, and the fourth y-axis antenna channel, adjusting the amplitudes of the test signals received by the second y-axis antenna channel, the third y-axis antenna channel, and the fourth y-axis antenna channel until the amplitudes of the test signals of the second y-axis antenna channel, the third y-axis antenna channel, and the fourth y-axis antenna channel are the same as the amplitudes of the test signals of the first y-axis antenna channel, and recording the corresponding first amplitude control values.

8. The method for calibrating the reception of the phased array antenna with the built-in local oscillator according to claim 3, wherein when performing a first calibration within a first ring area corner unit, the method comprises:
opening a first corner antenna channel, a second corner antenna channel, a third corner antenna channel, and a fourth corner antenna channel of the first ring area corner unit, transmitting test frequency signals by the transmitting antenna, receiving and obtaining corresponding test signals by the first corner antenna channel, the second corner antenna channel, the third corner antenna channel, and the fourth corner antenna channel of the phased array antenna, and the test signals comprise phase information and amplitude information;
based on phases of the test signals of the first corner antenna channel, obtaining first phase control values of corresponding phase shifters of the second corner antenna channel, the third corner antenna channel, and the fourth corner antenna channel, adjusting the phases of the test signals received by the second corner antenna channel, the third corner antenna channel, and the fourth corner antenna channel until the phases of the test signals of the second corner antenna channel, the third corner antenna channel, and the fourth corner antenna channel are the same as the phases of the test signals of the first corner antenna channel, and recording the corresponding first phase control values; and
based on amplitudes of the test signals of the first corner antenna channel, obtaining corresponding first amplitude control values of the second corner antenna channel, the third corner antenna channel, and the fourth corner antenna channel, adjusting the amplitudes of the test signals received by the second corner antenna channel, the third corner antenna channel, and the fourth corner antenna channel until the amplitudes of the test signals of the second corner antenna channel, the third corner antenna channel, and the fourth corner antenna channel are the same as the amplitudes of the test signals of a first x-axis antenna channel, and recording the corresponding first amplitude control values.

9. The method for calibrating the reception of the phased array antenna with the built-in local oscillator according to claim 3, wherein when performing a second calibration between the sub-units of the same ring area, the method comprises:
opening all corresponding antenna channels of two sub-units of calibrated same ring area, closing other antenna channels, transmitting test frequency signals by the transmitting antenna, and receiving and obtaining corresponding test signals of the two sub-units by opened antenna channels of the phased array antenna;
obtaining the test signals of all antenna channels within calibrated one of the sub-units and performing signal superimposition to synthesize a first synthesized signal;
obtaining the test signals of all antenna channels within calibrated another sub-unit and performing signal superimposition to synthesize a second synthesized signal;
synchronously controlling amplitude attenuations of all corresponding antenna channels of another sub-unit until amplitudes of the second synthesized signal of all corresponding antenna channels of the another sub-unit equals α1*P1, factor
$${α}_{1} = \frac{{D}^{2} + {d}_{2}^{2}}{{D}^{2} + {d}_{1}^{2}} ,$$
wherein D is a distance from the transmitting antenna to a phase center of the phased array antenna, d₂ is a distance from a phase center of another sub-unit to the phase center of the phased array antenna, d₁ is a distance from a phase center of one of the sub-units to the phase center of the phased array antenna, and P1 is an amplitude of the first synthesized signal, and obtaining and recording corresponding second amplitude control values; and
maintaining amplitudes and phases of all antenna channels of the one of the sub-units unchanged, synchronously transforming phases of all antenna channels in the another sub-unit until they are the same as a phase of the first synthesized signal of the one of the sub-units, obtaining and recording corresponding second phase control values.

10. The method for calibrating the reception of the phased array antenna with the built-in local oscillator according to claim 3, wherein when performing a third calibration between the ring areas, the method comprises:
opening all antenna channels of one sub-unit of a calibrated first ring area and all antenna channels of one sub-unit of a calibrated second ring area, closing other antenna channels, transmitting test frequency signals by the transmitting antenna, receiving and obtaining, by the phased array antenna, the test signals of all corresponding antenna channels of the one sub-unit of a first ring area and the test signals of all corresponding antenna channels of the one sub-unit of a second ring area, the test signals comprise phase information and amplitude information;
obtaining the test signals of all antenna channels within the one sub-unit of the calibrated second ring area and performing signal superimposition to synthesize a first synthesized signal;
obtaining the test signals of all antenna channels within the one sub-unit of the calibrated first ring area and performing signal superimposition to synthesize a second synthesized signal;
synchronously controlling amplitude attenuations of all corresponding antenna channels of the one sub-unit of the first ring area until amplitudes of the second synthesized signal of all corresponding antenna channels of the one sub-unit equals α3*P1, factor
$${α}_{3} = \frac{{D}^{2} + {d}_{4}^{2}}{{D}^{2} + {d}_{1}^{2}} ,$$
wherein D is a distance from the transmitting antenna to a phase center of the phased array antenna, d₄ is a distance from a phase center of the one sub-unit of the first ring area to the phase center of the phased array antenna, d₁ is a distance from a phase center of the one sub-unit of the second ring area to the phase center of the phased array antenna, and P1 is amplitudes of the first synthesized signal, and obtaining and recording corresponding third amplitude control values;
maintaining amplitudes and phases of all antenna channels of the one sub-unit of the second ring area unchanged, synchronously transforming phases of the second synthesized signal of all antenna channels of the one sub-unit of the first ring area until they are the same as the phases of the first synthesized signal of the one sub-unit of the second ring area, obtaining and recording corresponding third phase control values; and
opening sequentially all corresponding antenna channels of the one sub-unit of the first ring area and all corresponding antenna channels of the one sub-unit of other ring areas simultaneously.

11. The method for calibrating the reception of the phased array antenna with the built-in local oscillator according to claim 1, wherein a phase center of each of the centrally symmetric sub-units coincides with a physical center of the phased array antenna.

12. The method for calibrating the reception of the phased array antenna with the built-in local oscillator according to claim 1, further comprising:
using a multi-frequency point calibration method to perform multiple calibrations at different frequency points.

13. The method for calibrating the reception of the phased array antenna with the built-in local oscillator according to claim 1, wherein:
a signal source frequency is adjusted to a test frequency; and
a signal source power is adjusted to a transmission power based on a dynamic range and a sensitivity of the phased array antenna.

14. An electronic device, comprising:
a processor;
a memory coupled to the processor; and
a computer program stored in the memory and configured to be executed by the processor, wherein the processor, when executing the computer program, performs a method for calibrating a reception of a phased array antenna, wherein the method comprises:
constructing and configuring a test system, wherein the test system comprises a transmitting antenna and a signal source, the transmitting antenna is located on a central axis of the phased array antenna, and the transmitting antenna is connected to the signal source;
dividing the phased array antenna according to a layout of the phased array antenna, wherein the layout of the phased array antenna is divided into a plurality of centrally symmetric ring areas according to the central axis of the phased array antenna, and each of the ring areas comprise one or more centrally symmetric sub-units, and each of the sub-units comprises a same number of antenna channels; and
receiving signals using the phased array antenna and transmitting signals by the transmitting antenna, and performing amplitude and phase calibrations between the antenna channels within sub-units of the ring areas, between sub-units of the ring areas, and between the ring areas.

15. The electronic device according to claim 14, wherein the test system further comprises:
a control computer, wherein one end of the control computer is connected to the phased array antenna for configuring and controlling the antenna channels of the phased array antenna to receive signals, another end of the control computer is connected to the signal source, and the control computer is used to adjust frequency and power settings of the signal source.

16. The electronic device according to claim 14, wherein:
the sub-units comprise corner units, x-axis mirror units, and γ-axis mirror units;
the corner units are units of the antenna channels located at four corners of the ring areas;
the x-axis mirror units are units of the antenna channels located in an x-axis direction and centrally symmetric in the ring areas; and
the y-axis mirror units are units of the antenna channels located in a y-axis direction and centrally symmetric in the ring areas.

17. The electronic device according to claim 16, wherein the method further comprises:
performing a first calibration within the corner units, within the x-axis mirror units, and within the y-axis mirror units, respectively, to obtain first amplitude control values and first phase control values for the corresponding antenna channels;
performing a second calibration between the sub-units of the same ring area to obtain second amplitude control values and second phase control values for the corresponding antenna channels; and
performing a third calibration between the ring areas to obtain third amplitude control values and third phase control values for the corresponding antenna channels,
wherein the first amplitude control values, the second amplitude control values, and the third amplitude control values are summed to obtain final amplitude control values, and the first phase control values, the second phase control values, and the third phase control values are summed to obtain final phase control values.

18. The electronic device according to claim 16, wherein when performing a first calibration within a second ring area corner unit, the method comprises:
opening a first corner antenna channel, a second corner antenna channel, a third corner antenna channel, and a fourth corner antenna channel of the second ring area corner unit, transmitting test frequency signals by the transmitting antenna, receiving and obtaining corresponding test signals by the first corner antenna channel, the second corner antenna channel, the third corner antenna channel, and the fourth corner antenna channel of the phased array antenna, and the test signals comprise phase information and amplitude information;
based on phases of the test signals of the first corner antenna channel, obtaining first phase control values of corresponding phase shifters of the second corner antenna channel, the third corner antenna channel, and the fourth corner antenna channel, adjusting the phases of the test signals received by the second corner antenna channel, the third corner antenna channel, and the fourth corner antenna channel until the phases of the test signals of the second corner antenna channel, the third corner antenna channel, and the fourth corner antenna channel are the same as the phases of the test signals of the first corner antenna channel, and recording the corresponding first phase control values; and
based on amplitudes of the test signals of the first corner antenna channel, obtaining corresponding first amplitude control values of the second corner antenna channel, the third corner antenna channel, and the fourth corner antenna channel, adjusting the amplitudes of the test signals received by the second corner antenna channel, the third corner antenna channel, and the fourth corner antenna channel until the amplitudes of the test signals of the second corner antenna channel, the third corner antenna channel, and the fourth corner antenna channel are the same as the amplitudes of the test signals of the first corner antenna channel, and recording the corresponding first amplitude control values.

19. The electronic device according to claim 16, wherein when performing a first calibration within a second ring area x-axis mirror unit, the method comprises:
opening a first x-axis antenna channel, a second x-axis antenna channel, a third x-axis antenna channel, and a fourth x-axis antenna channel of a second ring area corner unit, transmitting test frequency signals by the transmitting antenna, receiving and obtaining corresponding test signals by the first x-axis antenna channel, the second x-axis antenna channel, the third x-axis antenna channel, and the fourth x-axis antenna channel of the phased array antenna, and the test signals comprise phase information and amplitude information;
based on phases of the test signals of the first x-axis antenna channel, obtaining first phase control values of corresponding phase shifters of the second x-axis antenna channel, the third x-axis antenna channel, and the fourth x-axis antenna channel, adjusting the phases of the test signals received by the second x-axis antenna channel, the third x-axis antenna channel, and the fourth x-axis antenna channel until the phases of the test signals of the second x-axis antenna channel, the third x-axis antenna channel, and the fourth x-axis antenna channel are the same as the phases of the test signals of the first x-axis antenna channel, and recording the corresponding first phase control values; and
based on amplitudes of the test signals of the first x-axis antenna channel, obtaining corresponding first amplitude control values of the second x-axis antenna channel, the third x-axis antenna channel, and the fourth x-axis antenna channel, adjusting the amplitudes of the test signals received by the second x-axis antenna channel, the third x-axis antenna channel, and the fourth x-axis antenna channel until the amplitudes of the test signals of the second x-axis antenna channel, the third x-axis antenna channel, and the fourth x-axis antenna channel are the same as the amplitudes of the test signals of the first x-axis antenna channel, and recording the corresponding first amplitude control values.

20. The electronic device according to claim 16, wherein when performing a first calibration within a second ring area y-axis mirror unit, the method comprises:
opening a first y-axis antenna channel, a second y-axis antenna channel, a third y-axis antenna channel, and a fourth y-axis antenna channel of a second ring area corner unit, transmitting test frequency signals by the transmitting antenna, receiving and obtaining corresponding test signals by the first y-axis antenna channel, the second y-axis antenna channel, the third y-axis antenna channel, and the fourth y-axis antenna channel of the phased array antenna, and the test signals comprise phase information and amplitude information;
based on phases of the corresponding test signals of the first y-axis antenna channel, obtaining first phase control values of corresponding phase shifters of the second y-axis antenna channel, the third y-axis antenna channel, and the fourth y-axis antenna channel, adjusting the phases of the test signals received by the second y-axis antenna channel, the third y-axis antenna channel, and the fourth y-axis antenna channel until the phases of the test signals of the second y-axis antenna channel, the third y-axis antenna channel, and the fourth y-axis antenna channel are the same as the phases of the test signals of the first y-axis antenna channel, and recording the corresponding first phase control values; and
based on amplitudes of the test signals of the first y-axis antenna channel, obtaining corresponding first amplitude control values of the second y-axis antenna channel, the third y-axis antenna channel, and the fourth y-axis antenna channel, adjusting the amplitudes of the test signals received by the second y-axis antenna channel, the third y-axis antenna channel, and the fourth y-axis antenna channel until the amplitudes of the test signals of the second y-axis antenna channel, the third y-axis antenna channel, and the fourth y-axis antenna channel are the same as the amplitudes of the test signals of the first y-axis antenna channel, and recording the corresponding first amplitude control values.
